(19) United States
(12) Patent Application Publication
(10) Pub. No.: US 2008/0028923 A1
(43) Pub. Date: Feb. 7, 2008

(54) HYDRAULIC STROKING DEVICE, PLANETARY GEAR AUTOMATIC TRANSMISSION, AND CLUTCH APPARATUS

(75) Inventors: Hirofumi Fujita, Toyota-shi (JP); Kazuyuki Watanabe, Anjo-shi (JP); Kazuaki Nakamura, Toyota-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/833,469

(22) Filed: Aug. 3, 2007

(30) Foreign Application Priority Data
Aug. 7, 2006 (JP) 2006-214548

(51) Int. Cl. F15B 9/10; F02F 11/00; F16D 11/00; F16H 31/00

(52) U.S. Cl. 91/375 R; 192/46; 277/595; 475/146

(57) ABSTRACT

A hydraulic stroking device that performs stroking action by adjusting a pressure of hydraulic fluid in a fluid chamber is disclosed. The hydraulic device includes a hydraulic piston, a sealing member, and a variable sealing performance mechanism. The piston is provided in a fluid chamber, and receives the pressure of hydraulic fluid and is moved by the pressure. The sealing member seals between a circumferential surface of the piston and an inner surface of the fluid chamber. When the piston is not moving with the hydraulic fluid being pressurized, the variable sealing performance mechanism enhances the sealing performance of the sealing member compared to the sealing performance in a state when the piston is being moved.

### BACKGROUND OF THE INVENTION

The present invention relates to a hydraulic stroking device that performs stroking action by adjusting the pressure of hydraulic fluid, and a planetary gear automatic transmission and a clutch apparatus that use the stroking device.

A planetary gear automatic transmission has a hydraulic stroking device such as a hydraulic servo. When gear is shifted by the transmission, the stroking device actuates the clutch and the brake in the transmission. To improve the responsiveness of such a transmission, there have been attempts to accelerate the engagement and disengagement of the clutch or brake.

Japanese Laid-Open Patent Publication No. 2005-98432 discloses a technique for improving the responsiveness of a transmission having a hydraulic servo. In this technique, the number of seal rings, which are provided for maintaining the oil tightness of hydraulic fluid, is decreased, so that the sliding resistance of the seal rings is reduced.

Although the number of the seal rings can be reduced, it is impossible to remove all the seal rings because of the need for oil tightness. Accordingly, there is a limit to the reduction of the sliding resistance achieved by reducing the number of the seal rings. Particularly, at lower temperatures, the sliding resistance of the seal rings is increased. Thus, even if the number of the seal rings is reduced, the responsiveness of the transmission deteriorates.

In such a case, the sliding resistance can be reduced by adjusting the clearance gap of the seal rings. However, such adjustment of the clearance gap reduces the sealing performance of the seal rings, which causes leakage of hydraulic fluid. As a result, the responsiveness is likely to deteriorate. Therefore, it is hard to reduce the sliding resistance by means of such a technique.

As described above, to achieve prompt gear shifting of a planetary gear automatic transmission, the sliding resistance of sealing members in the hydraulic servo such as seal rings need to be reduced. Reduction of the sliding resistance of sealing member is desired not only for planetary gear automatic transmissions, but also for devices in other areas. For example, there have been demands for reduction of the sliding resistance in multi-plate clutch type limited slip differentials typically used in a center differential to improve the responsiveness. A limited slip differential has a hydraulic stroking device for controlling a multi-plate clutch.

### SUMMARY OF THE INVENTION

Accordingly, it is an objective of the present invention to provide a hydraulic stroking device the responsiveness of which is improved by reducing sliding resistance, without causing leakage of hydraulic fluid, and a planetary gear automatic transmission and a clutch apparatus that use the hydraulic stroking device.

To achieve the foregoing objective and in accordance with a first aspect of the present invention, a hydraulic stroking device that performs stroking action by adjusting a pressure of hydraulic fluid in a hydraulic fluid chamber is provided. The device includes a piston, a sealing member, and a variable sealing performance mechanism. The piston is provided in the hydraulic fluid chamber. The piston receives the pressure of the hydraulic fluid and is moved by the pressure. The sealing member seals between a circumferential surface of the piston and an inner surface of the hydraulic fluid chamber. When the piston is not moving with the hydraulic fluid being pressurized, the variable sealing performance mechanism enhances the sealing performance of the sealing member compared to the sealing performance in a state when the piston is being moved.

In accordance with a second aspect of the present invention, a planetary gear automatic transmission including the hydraulic stroking device according to the first aspect and either a clutch or a brake is provided. The stroking device functions to selectively engage and disengage the clutch or brake.

In accordance with a third aspect of the present invention, a clutch apparatus including the hydraulic stroking device according to the first aspect and a multi-plate clutch is provided. The stroking device functions to selectively engage and disengage the multi-plate clutch.

In accordance with a fourth aspect of the present invention, a hydraulic stroking device that performs stroking action by adjusting a pressure of hydraulic fluid in a hydraulic fluid chamber is provided. The device includes a piston, a seal support, an urging member, and a sealing member is provided. The piston is provided in the hydraulic fluid chamber. The piston receives the pressure of the hydraulic fluid and is moved by the pressure. The piston has a first surface that receives the pressure of the hydraulic fluid in the hydraulic fluid chamber, and a second surface located on a side opposite to the first surface. The seal support is separately formed from the piston and located in the hydraulic fluid chamber. The seal support selectively intimately contacts and separates from the second surface of the piston. The urging member urges the seal support toward the second surface of the piston. The sealing member is provided in the seal support and seals between an inner surface of the hydraulic fluid chamber and the seal support.

In accordance with a fifth aspect of the present invention, a planetary gear automatic transmission including the hydraulic stroking device according to the fourth aspect and either a clutch or a brake is provided. The stroking device functions to selectively engage and disengage the clutch or brake.

In accordance with a sixth aspect, a clutch apparatus including the hydraulic stroking device according to the fourth aspect and a multi-plate clutch is provided. The stroking device functions to selectively engage and disengage the multi-plate clutch.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a longitudinal cross-sectional view illustrating substantial parts of an automatic transmission in which a hydraulic stroking device according to a first embodiment is used;

FIGS. 2A and 2B are diagrams illustrating an operation of the hydraulic stroking device shown in FIG. 1;

FIGS. 3A and 3B are timing charts showing a process of an operation of the hydraulic stroking device shown in FIG. 1;

FIG. 4 is a longitudinal cross-sectional view illustrating substantial parts of an automatic transmission in which a hydraulic stroking device according to a second embodiment is used;

FIG. 5 is a cross-sectional view taken along line 5-5 of FIG. 4;

FIGS. 6A and 6B are diagrams illustrating the operation of the hydraulic stroking device according to the second embodiment;

FIG. 7 is a timing chart showing a process of an operation of the hydraulic stroking device according to the second embodiment;

FIG. 8 is a longitudinal cross-sectional view illustrating substantial parts of an automatic transmission in which a hydraulic stroking device according to a third embodiment is used;

FIGS. 9A and 9B are diagrams illustrating the operation of the hydraulic stroking device according to the third embodiment;

FIG. 10 is a longitudinal cross-sectional view illustrating substantial parts of an automatic transmission in which a hydraulic stroking device according to a fourth embodiment is used; and

FIG. 11 is a diagram illustrating another embodiment.

### DETAILED DESCRIPTION OF THE PREFERRED EMBODIMENTS

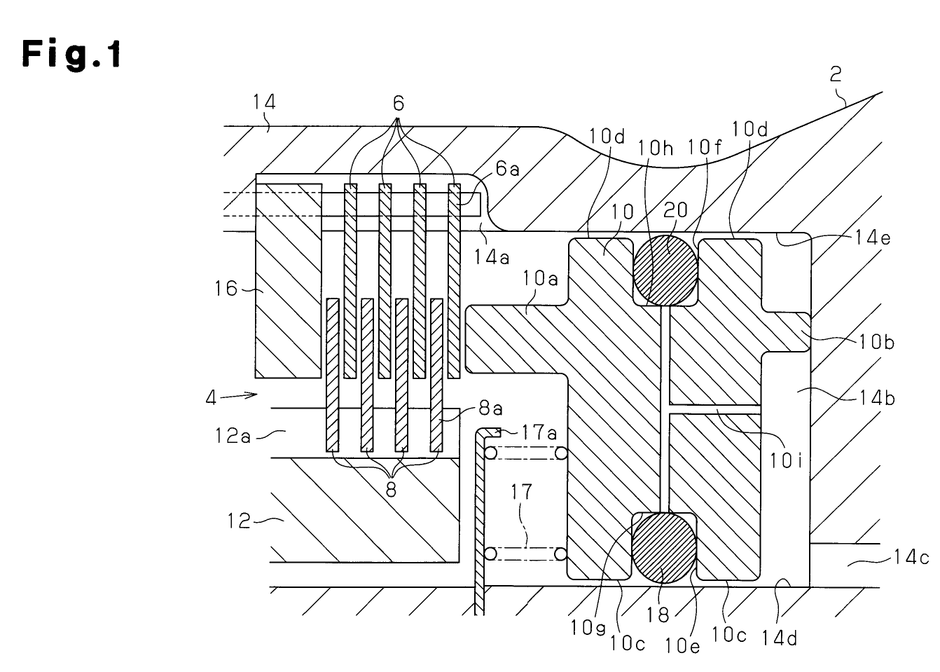

FIG. 1 is a longitudinal cross-sectional view illustrating substantial parts of a planetary gear automatic transmissions (hereinafter, simply referred to as automatic transmission) 2 according to a first embodiment. The automatic transmission 2 includes several brakes, and FIG. 1 shows one of the brakes (a brake 4). The brake 4 has a multi-plate clutch and a hydraulic stroking device. The multi-plate clutch has driven plates 6 and drive plates 8. The driven plates 6 are located at a radially outer portion of the automatic transmission 2, and the drive plates 8 are located at a radially inner portion of the automatic transmission 2. Adjacent pairs of the driven plates 6 and the drive plates 8 are caused to contact each other by the actuation of a hydraulic piston of the hydraulic stroking device, so that frictional force is generated between the driven plates 6 and the drive plates 8. The frictional force engages the driven plates 6 and the drive plates 8 to each other, so that rotation of a rotor 12, which is meshed with the drive plates 8, is braked.

A spline 14a is formed on an inner surface of a gearbox 14 of the automatic transmission 2. The spline 14a is meshed with a spline edge 6a on the outer circumference of each driven plate 6. On the other hand, the rotor 12 is rotatably supported by a member located at a radially inner portion of the automatic transmission 2 with a bearing. A spline 12a provided on the outer circumference of the rotor 12 is engaged with a spline edge 8a formed on the inner circumference of each drive plate 8. The above configuration prevents the driven plates 6 from rotating relative to the gearbox 14, but allows the driven plates 6 to move along the spline 14a in the axial direction of the automatic transmission 2. The drive plates 8 rotates integrally with the rotor 12 and moves along the spline 12a in the axial direction of the automatic transmission 2.

The driven plates 6 and the drive plates 8 are alternately arranged in the axial direction of the automatic transmission 2. In this state, the driven plates 6 and the drive plates 8 are located between a retaining plate 16 and a pressing projection 10a of the hydraulic piston 10. The hydraulic piston 10 is located in a hydraulic pressure chamber 14b defined in the gearbox 14, and is slidable along the axial direction of the gearbox 14. The hydraulic piston 10 is movable toward the multi-plate clutch by hydraulic pressure supplied to the hydraulic pressure chamber 14b through a hydraulic passage 14c. A spring seat 17a is located in the gearbox 14 at a side of the hydraulic piston 10 opposite to the hydraulic passage 14c. A compression spring 17 is located between the spring seat 17a and the hydraulic piston 10. The compression spring 17 urges the hydraulic piston 10 in a direction away from the multi-plate clutch. FIG. 1 shows a state in which the hydraulic piston 10 is held at the farthest position from the multi-plate clutch by the compression spring 17. In this state, a stopper 10b of the hydraulic piston 10 contacts an end face of the hydraulic pressure chamber 14b, and the hydraulic piston 10 is prevented from moving further away from the multi-plate clutch.

When hydraulic pressure is supplied to the hydraulic pressure chamber 14b through the hydraulic passage 14c, the hydraulic piston 10 moves toward the driven plates 6 while compressing the compression spring 17. Accordingly, the pressing projection 10a contacts the driven plates 6, and holds the overlapping sections of the driven plates 6 and the drive plates 8 with the retaining plate 16. The holding force generates frictional force between contact surfaces of the driven plates 6 and contact surfaces of the drive plates 8. This applies braking torque to the rotor 12, and thus stops the rotation of rotor 12.

When the supply of hydraulic pressure through the hydraulic passage 14c is stopped, the hydraulic piston 10 is returned to the state shown in FIG. 1 by the urging force of the compression spring 17. This disengages the brake 4. That is, no braking torque is applied to the rotor 12, and the braking of the rotation of the rotor 12 is cancelled.

The hydraulic piston 10 has an inner circumferential surface 10c and an outer circumferential surface 10d. A circumferentially extending seal ring groove 10e is formed on the inner circumferential surface 10c. A circumferentially extending seal ring groove 10f is formed on the outer circumferential surface 10d. Seal rings 18, 20, serving as sealing members, are located in the seal ring grooves 10e, 10f, respectively. The seal ring 18 seals between the inner circumferential surface 10c of the hydraulic piston 10 and an inner surface 14d of the hydraulic pressure chamber 14b, which faces the inner circumferential surface 10c. The seal ring 20 seals between the outer circumferential surface 10d of the hydraulic piston 10 and an inner surface 14e of the hydraulic pressure chamber 14b, which faces the outer circumferential surface 10d.

The seal ring grooves 10e, 10f communicate with a hydraulic passage 10i formed in the hydraulic piston 10. The hydraulic pressure for actuating the hydraulic piston 10 is supplied from the hydraulic pressure chamber 14b to the interior of the seal ring grooves 10e, 10f through the hydraulic passage 10i. The wire diameter of each of the seal ring 18, 20 is greater than the width of the corresponding one of the seal ring grooves 10e, 10f. Therefore, the seal rings 18, 20 create a closed space between the seal rings 18, 20 and inner bottoms 10g, 10h of seal ring grooves 10e, 10f that face the seal rings 18, 20, respectively. Further, since the outer diameter of the seal ring 18 is slightly greater than the diameter of the inner bottom 10g of the seal ring groove 10e, the entire outer circumference of the seal ring 18 contacts the inner bottom 10g. Since the inner diameter of the seal ring 20 is slightly less than the diameter of the inner bottom 10h of the seal ring groove 10f, the entire inner circumference of the seal ring 20 contacts the inner bottom 10h.

Thus, in a state where the hydraulic pressure in the hydraulic pressure chamber 14b is not raised, the seal rings 18, 20 keep contacting the inner bottoms 10g, 10h, respectively, as shown in FIG. 1, and do not contact the inner surfaces 14d, 14e of the hydraulic pressure chamber 14b.

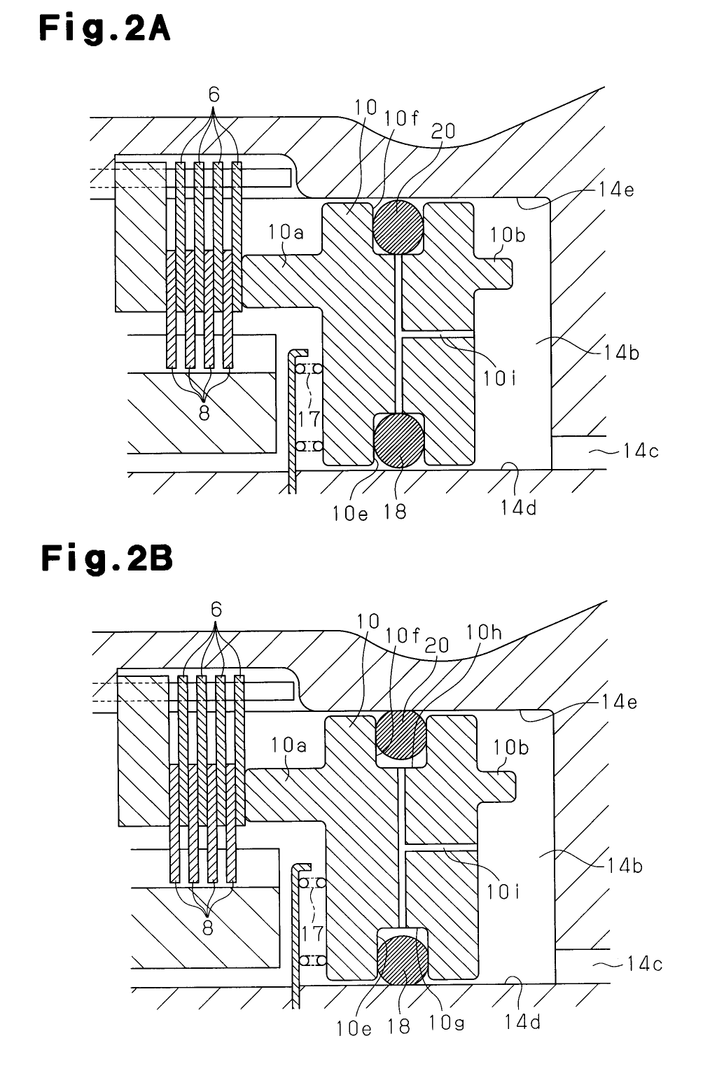

When the hydraulic pressure is supplied to the hydraulic pressure chamber 14b through the hydraulic passage 14c to activate the brake 4, the pressing projection 10a of the hydraulic piston 10 presses the driven plates 6 and the drive plates 8 as shown in FIG. 2A. This brakes the rotation of the rotor 12 as described above. When the stroking action of the hydraulic piston 10 for the braking is completed and the hydraulic piston 10 stops, the hydraulic pressure in the hydraulic pressure chamber 14b is further raised. Accordingly, the hydraulic fluid is further supplied into the seal ring grooves 10e, 10f through the hydraulic passage 10i, so that the hydraulic pressure in the seal ring grooves 10e, 10f is further raised. Each of the seal rings 18, 20 is thus pushed toward the outside of the corresponding one of the seal ring grooves 10e, 10f, or toward the corresponding one of the inner surfaces 14d, 14e of the hydraulic pressure chamber 14b. Then, as shown in FIG. 2B, the seal rings 18, 20 contact the inner surfaces 14d, 14e of the hydraulic pressure chamber 14b, respectively, and are pressed against the inner surfaces 14d, 14e. This allows the seal rings 18, 20 to exert an enhanced sealing performance for hydraulic fluid.

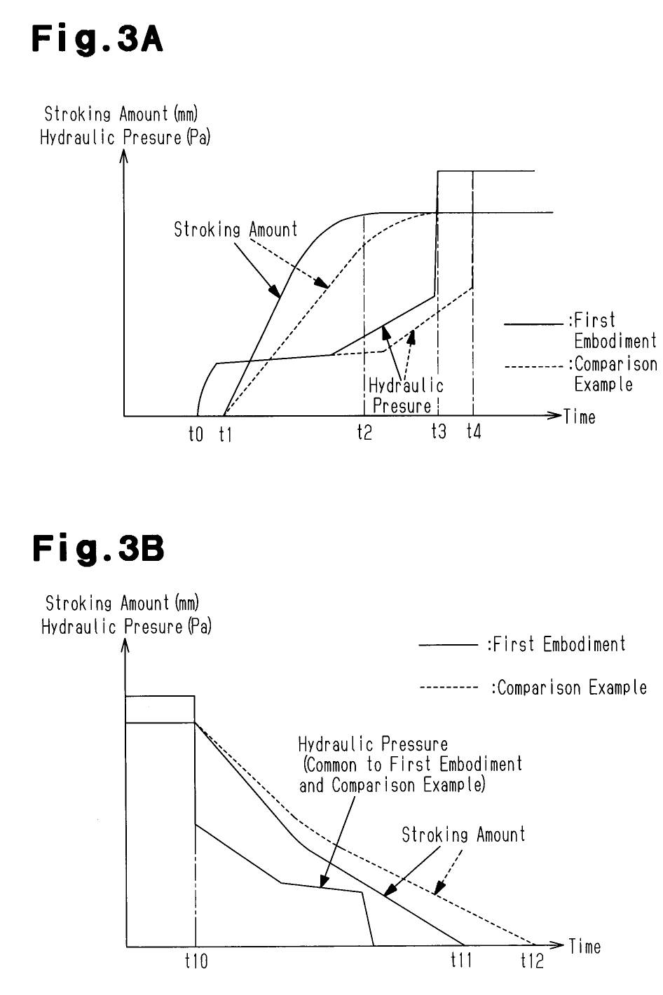

FIG. 3A is a timing chart showing changes of the amount of stroke (mm) of the hydraulic piston 10 and the hydraulic pressure (Pa) in the hydraulic pressure chamber 14b. Solid lines in FIG. 3A show changes according to the present embodiment. Even if the hydraulic piston 10 is moved by hydraulic pressure, the hydraulic pressure in the hydraulic pressure chamber 14b is not significantly raised as shown in FIG. 3A. Therefore, each of the seal rings 18, 20 does not contact or barely contacts the corresponding one of the inner surfaces 14d, 14e of the hydraulic pressure chamber 14b. Thus, when compared to a comparison example represented by broken lines, which will be discussed below, the stroking amount of the hydraulic piston 10 is rapidly increased (t1-t2).

If the hydraulic piston 10 is stopped while the supply of hydraulic pressure is continued, the hydraulic pressure in the hydraulic pressure chamber 14b is further raised (t3). This increases the hydraulic pressure supplied into the seal ring grooves 10e, 10f through the hydraulic passage 10i in the hydraulic piston 10, or a back pressure acting on the seal rings 18, 20. Then, as shown in FIG. 2B, the seal rings 18, 20 are pressed against the inner surfaces 14d, 14e of the hydraulic pressure chamber 14b, respectively, and the sealing performance between the hydraulic piston 10 and the inner surfaces 14d, 14e of the hydraulic pressure chamber 14b is enhanced. Thus, as in the comparison example, leakage of hydraulic fluid from the hydraulic pressure chamber 14b is prevented.

A stroking device of the comparison example is not provided with the hydraulic passage 10i. Each seal ring of this stroking device is sufficiently pressed against the corresponding one of the inner surfaces 14d, 14e of the hydraulic pressure chamber 14b regardless of the hydraulic pressure. That is, the stroking device of the comparison example exerts the sealing performance from the beginning of the movement of the hydraulic piston. Thus, in the comparison example, a great friction force is generated between each seal ring and the corresponding one of the inner surfaces 14d, 14e of the hydraulic pressure chamber 14b from the beginning. Therefore, the stroking amount is slowly increased (t1-t3), which delays the engagement of the brake 4.

When the brake 4 is disengaged, the hydraulic pressure in the hydraulic pressure chamber 14b is lowered as shown in FIG. 3B (t10). This conducts the hydraulic fluid from the seal ring grooves 10e, 10f through the hydraulic passage 10i in the hydraulic piston 10, and the back pressure acting on the seal rings 18, 20 is lowered. Accordingly, each of the seal rings 18, 20 gradually reduces the pressure applied to the corresponding one of the inner surfaces 14d, 14e of the hydraulic pressure chamber 14b. Thus, the sealing performance between the hydraulic piston 10 and the inner surfaces 14d, 14e is gradually reduced (t10-t11). Since the frictional force between the seal rings 18, 20 and the inner surfaces 14d, 14e of the hydraulic pressure chamber 14b is reduced, the stroking amount of the hydraulic piston 10 is promptly deceased by the urging force of the compression spring 17, which disengages the brake 4. In the comparison example, a great frictional force is generated between the seal rings 18, 20 and the inner surfaces 14d, 14e of the hydraulic pressure chamber 14b, and the frictional force is maintained regardless of the supplied hydraulic pressure. Since the frictional force acts against the urging force of the compression spring 17, the stroking amount is reduced slowly (t10-t12), which delays the disengagement of the brake 4.

The first embodiment described above has the following advantages.

(1) In a state where the hydraulic piston 10 is not moving with the hydraulic pressure has been raised, a variable sealing performance mechanism configured by the hydraulic passage 10i in the hydraulic piston 10 and the seal rings 18, 20 enhances the sealing performance of the seal rings 18, 20 in comparison to that in the period in which the hydraulic piston 10 is being moved. During the period in which the hydraulic piston 10 is moving, the variable sealing performance mechanism sets the sealing performance of the seal rings 18, 20 lower than that required for oil tightness. Due to the reduction of the sealing performance, the sliding resistance caused by the friction of the seal rings 18, 20 is lowered. This lowers the resistance received by the moving hydraulic piston 10 from the inner surfaces 14d, 14e of the hydraulic pressure chamber 14b through the seal rings 18, 20.

Therefore, in the present embodiment, the responsiveness of the brake 4 is improved by reducing the sliding resistance of the hydraulic piston 10 when it moves. In a period when oil tightness is required, that is, in a period when the hydraulic fluid is pressurized and the hydraulic piston 10 is not moving, the sealing performance of the seal rings 18, 20 is enhanced by raising the hydraulic pressure of the hydraulic passage 10i. That is, when the hydraulic pressure is increased, each of the seal rings 18, 20 is moved toward the corresponding one of the inner surfaces 14d, 14e of the hydraulic pressure chamber 14b. The contact area of each of the inner surfaces 14d, 14e and the corresponding one of the seal rings 18, 20 is enlarged. As a result, hydraulic fluid does not leak from the hydraulic pressure chamber 14b.

(2) The variable sealing performance mechanism is configured by forming the hydraulic passage 10i in the hydraulic piston 10. The sealing performance of the seal rings 18, 20 are made variable by such a simple construction.

(3) The variable sealing performance mechanism is installed in the brake 4 having a multi-plate clutch. Therefore, the responsiveness of the automatic transmission 2 is improved so that prompt shift change is possible.

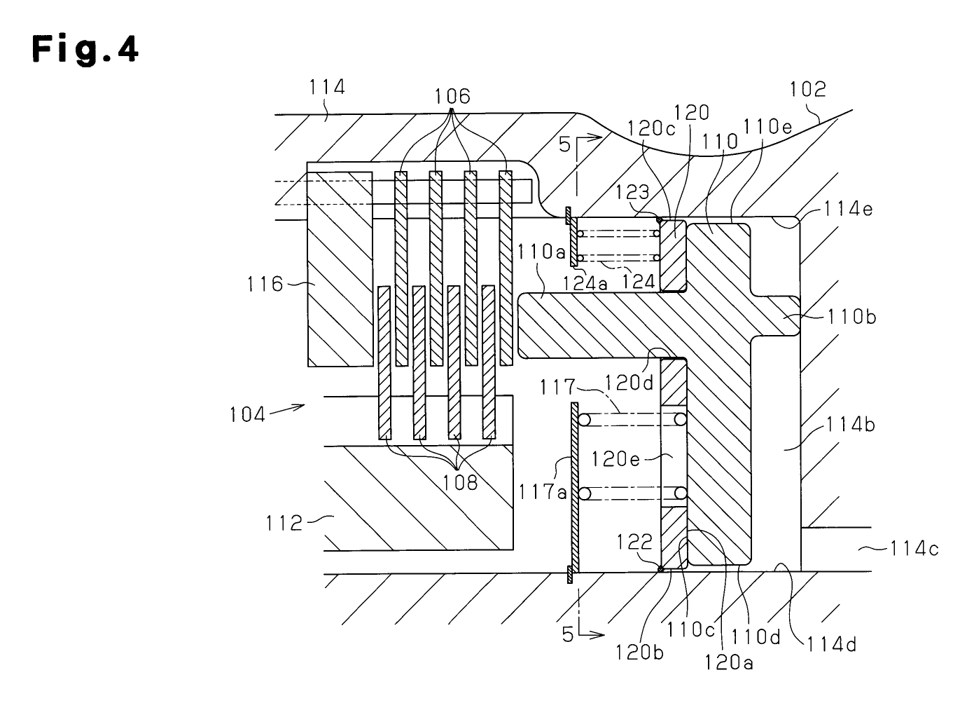

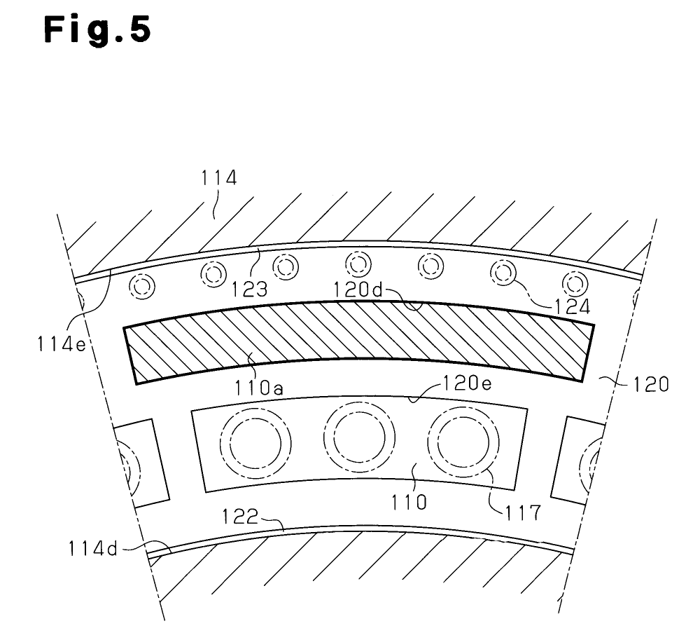

An automatic transmission 102 according to a second embodiment has a brake 104 as shown in cross-sectional views of FIGS. 4 and 5. FIG. 5 is a cross-sectional view taken along line 5-5 of FIG. 4. The brake 104 includes driven plates 106, drive plates 108, a rotor 112, a gearbox 114, and a retaining plate 116, the configurations of these components are the same as those in the first embodiment. On the other hand, a hydraulic stroking device in the brake 104 is different from that in the first embodiment.

The hydraulic stroking device of the present embodiment has a hydraulic piston 110, a compression spring 117 for the hydraulic piston 110, a seal support 120, lip seal members 122, 123, and a compression spring 124 for the seal support 120.

The hydraulic piston 110 is provided in a hydraulic pressure chamber 114b defined in the gearbox 114. The hydraulic piston 110 is movable toward a multi-plate clutch by hydraulic pressure supplied through a hydraulic passage 114c. A spring seat 117a is located in the gearbox 114 at a side of the hydraulic piston 110 opposite to the hydraulic passage 114c. A compression spring 117 is located between the spring seat 117a and the hydraulic piston 110. The compression spring 117 urges the hydraulic piston 110 in a direction away from the multi-plate clutch. FIG. 4 shows a state in which the hydraulic piston 110 is held at the farthest position from the multi-plate clutch by the urging force of the compression spring 117. In this state, a stopper 110b formed on hydraulic piston 110 contacts an end face of the hydraulic pressure chamber 114b.

The seal support 120 is located in the gearbox 114 at a side of the hydraulic piston 110 opposite to the hydraulic passage 114c. The seal support 120 has an intimate contact surface 120a, which intimately contacts a portion of a surface 110c of the hydraulic piston 110 except for the pressing projection 110a and a portion contacting the compression spring 117. A lip seal member 122 is provided on an inner circumferential surface 120b of the seal support 120. The lip seal member 122 seals between an inner surface 114d of the hydraulic pressure chamber 114b and the seal support 120. A lip seal member 123 is formed on an outer circumferential surface 120c of the seal support 120. The lip seal member 123 seals between an inner surface 114e of the hydraulic pressure chamber 114b and the seal support 120. A spring seat 124a is provided on the inner surface 114e of the hydraulic pressure chamber 114b at the same position in the axial direction of the gearbox 114 as the spring seat 117a for the hydraulic piston 110. The compression spring 124 is located between the spring seat 124a and the seal support 120. The compression spring 124 urges the seal support 120 toward the hydraulic piston 110.

The pressing projection 110a of the hydraulic piston 110 extends through a through hole 120d formed in the seal support 120, and the distal end of the pressing projection 110a faces one of the driven plates 106. The compression spring 117 extends through a through hole 120e formed in the seal support 120, and is located between the spring seat 117a and the surface 110c of the hydraulic piston 110.

When hydraulic pressure is supplied to the hydraulic pressure chamber 114b through the hydraulic passage 114c, the hydraulic piston 110 moves toward the multi-plate clutch while compressing the compression spring 117. At this time, the surface 110c of the hydraulic piston 110 intimately contacts the intimate contact surface 120a of the seal support 120. In this state, the hydraulic piston 110 moves together with the seal support 120 toward the multi-plate clutch. Although no sealing members such as seal rings are provided on the circumferential surfaces 110d, 110e of the hydraulic piston 110, hydraulic fluid does not leak out from the hydraulic pressure chamber 114b. Specifically, since the surface 110c of the hydraulic piston 110 and the intimate contact surface 120a of the seal support 120 closely contact each other, hydraulic fluid does not leak from the hydraulic pressure chamber 114b to the through hole 120d, 120e through the intimately contacting portions. Further, the lip seal members 122, 123 seal between the circumferential surfaces 120b, 120c of the seal support 120 and the inner surfaces 114d, 114e of the hydraulic pressure chamber 114b, respectively. Thus, the hydraulic fluid in the hydraulic pressure chamber 114b does leak between the seal support 120 and the inner surfaces 114d, 114e of the hydraulic pressure chamber 114b.

In this manner, the hydraulic piston 110, which has moved toward the multi-plate clutch, holds overlapping sections of the driven plates 106 and the drive plates 108 with the retaining plate 116. The holding force generates frictional force between contact surfaces of the driven plates 106 and contact surfaces of the drive plates 108, so that the brake 104 is engaged. This brakes the rotation of the rotor 112.

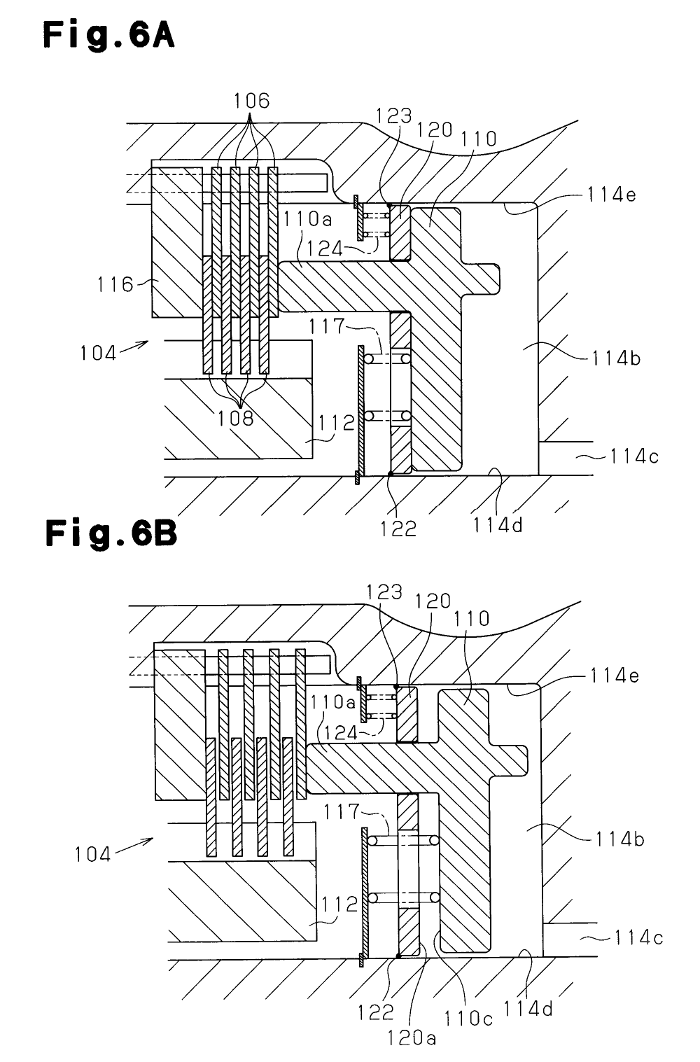

When the hydraulic fluid is conducted out of the hydraulic pressure chamber 114b through the hydraulic passage 114c to disengage the brake 104, the hydraulic piston 110 is moved away from the multi-plate clutch by the urging force of the compression spring 117 as shown in FIG. 6B. When the seal support 120 receives an urging force in a direction away from the multi-plate clutch from the compression spring 124, the lip seal member 122, 123 receives sliding resistance. Accordingly, the seal support 120 also receives transfer resistance. Since the seal support 120 is formed independently from the hydraulic piston 110, the seal support 120 separates from the hydraulic piston 110 as shown in FIG. 6B. As a result, the movement of the seal support 120 is delayed.

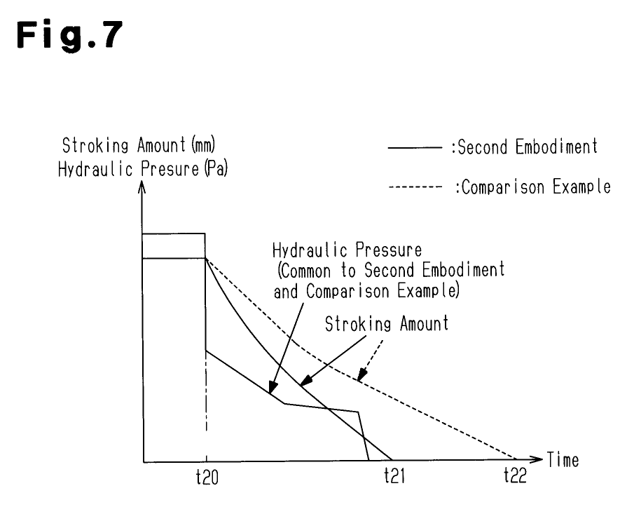

When the brake 104 is disengaged, the hydraulic piston 110 does not receive sliding resistance of the lip seal members 122, 123. Therefore, when the hydraulic pressure in the hydraulic pressure chamber 114b is lowered as indicated by a solid line in the timing chart of FIG. 7 (t20), the hydraulic piston 110 separates from the seal support 120, and the stroking amount of the hydraulic piston 110 is rapidly reduced by the urging force of the compression spring 117 (t20-t21). That is, the brake 104 is promptly disengaged. After the hydraulic piston 110 returns to the initial position when the stopper 110b of the hydraulic piston 110 contacts the end face of the hydraulic pressure chamber 114b, the seal support 120 overtakes the hydraulic piston 110. Accordingly, the brake 104 returns to the state shown in FIG. 4.

Broken line in FIG. 7 represents a case of a brake of a comparison example. This brake is not provided with the seal support 120, and the lip seal members 122, 123 are attached to the hydraulic piston 110. In such a comparison example, the frictional force between each of the lip seal members 122, 123 and the corresponding one of the inner surfaces 114d, 114e of the hydraulic pressure chamber 114b is great. The fictional force thus acts as resistance against the urging force of the compression spring 117. Therefore, the stroking amount of the hydraulic piston 110 is slowly reduced (t20-t22), which delays the disengagement of the brake 104.

The second embodiment described above has the following advantages.

(1) The lip seal members 122, 123 are not provided on the hydraulic piston 110, but provided on the seal support 120, which is formed separately from the hydraulic piston 110. The seal support 120 can be selectively brought into close contact with and separated from the hydraulic piston 110. Thus, when the compression spring 124, which serves as a seal support urging member, causes the seal support 120 to closely contact the hydraulic piston 110, the lip seal members 122, 123 indirectly seal the spaces between the hydraulic piston 110 and the inner surfaces 114d, 114e of the hydraulic pressure chamber 114b.

When the hydraulic piston 110 moves toward multi-plate clutch, the hydraulic piston 110 and the seal support 120 are maintained in a closely contacting state as described above. Thus, even during a period in which the hydraulic piston 110 is not moving with the hydraulic fluid pressurized, the lip seal members 122, 123 indirectly seal the spaces between the hydraulic piston 110 and the inner surfaces 114d, 114e of the hydraulic pressure chamber 114b.

When the hydraulic piston 110 is moved away from the seal support 120 by the compression spring 117, the resistance generated by the sliding of the lip seal members 122, 123 acts on the seal support 120. However, since the hydraulic piston 110 is formed separately from the seal support 120 and moves away from the seal support 120, the transfer resistance of the lip seal members 122, 123 does not act on the hydraulic piston 110. Thus, the hydraulic piston 110 can be rapidly moved away from the seal support 120. In this manner, the responsiveness of the hydraulic stroking device is improved in a direction reducing the stroking amount of the hydraulic piston 110.

As described above, the responsiveness of the automatic transmission 102 is improved by reducing the sliding resistance regardless of the reduction in the number of the lip seal members 122, 123, without causing leakage of hydraulic fluid.

(2) The advantage of the item (3) of the first embodiment is obtained.

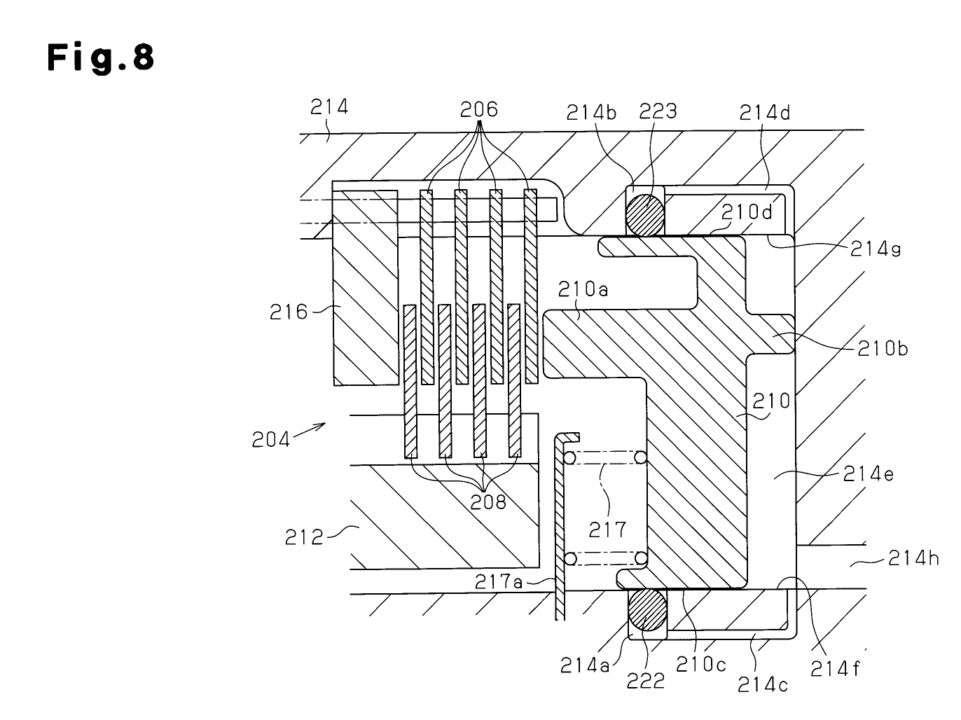

An automatic transmission 202 according to a third embodiment has a brake 204 as shown in a cross-sectional view of FIG. 8. The brake 204 includes driven plates 206, drive plates 208, a rotor 212, and a retaining plate 216, the configurations of these components are the same as those in the first embodiment. On the other hand, a hydraulic stroking device in the brake 204 is different from that in the first embodiment.

The hydraulic stroking device of the present embodiment has a hydraulic piston 210, a compression spring 217, seal ring grooves 214a, 214b, hydraulic passages 214c, 214d, and seal rings 222, 223.

The seal ring grooves 214a, 214b are formed on inner surfaces of a hydraulic pressure chamber 214e, respectively. The seal rings 222, 223 are located in the seal ring grooves 214a, 214b, respectively. To apply back pressure to the seal rings 222, 223, hydraulic passages 214c, 214d are formed in a gearbox 214 to connect the seal ring grooves 214a, 214b and the hydraulic pressure chamber 214e to each other.

The hydraulic piston 210 is provided in a hydraulic pressure chamber 214e defined in the gearbox 214. The hydraulic piston 210 is movable toward a multi-plate clutch by hydraulic pressure supplied through a hydraulic passage 214h. A spring seat 217a is located in the gearbox 214 at a side of the hydraulic piston 210 opposite to the hydraulic passage 214h. A compression spring 217 is located between the spring seat 217a and the hydraulic piston 210. The compression spring 217 urges the hydraulic piston 210 in a direction away from the multi-plate clutch. FIG. 8 shows a state in which the hydraulic piston 210 is held at the farthest position from the multi-plate clutch by the compression spring 217. In this state, a stopper 210b formed on hydraulic piston 210 contacts an end face of the hydraulic pressure chamber 214e.

Each of the seal rings 222, 223 is located in the corresponding one of the seal ring grooves 214a, 214b. The wire diameter of each of the seal ring 222, 223 is greater than the width of the corresponding one of the seal ring grooves 214a, 214b. Therefore, the seal rings 222, 223 create a closed space between the seal rings 222, 223 and inner bottoms of seal ring grooves 214a, 214b that face the seal rings 222, 223, respectively. Also, each of the seal rings 222, 223 has such an outer diameter that it is entirely accommodated in the corresponding one of the seal ring grooves 214a, 214b when placed therein. Therefore, in a state where the hydraulic pressure in the hydraulic pressure chamber 214e has not been raised, the seal rings 222, 223 barely contact circumferential surfaces 210c, 210d of the hydraulic piston 210, respectively, as shown in FIG. 8. The seal rings 222, 223 may be located in the seal ring grooves 214a, 214b in a state separated from the circumferential surfaces 210c, 210d of the hydraulic piston 210, respectively.

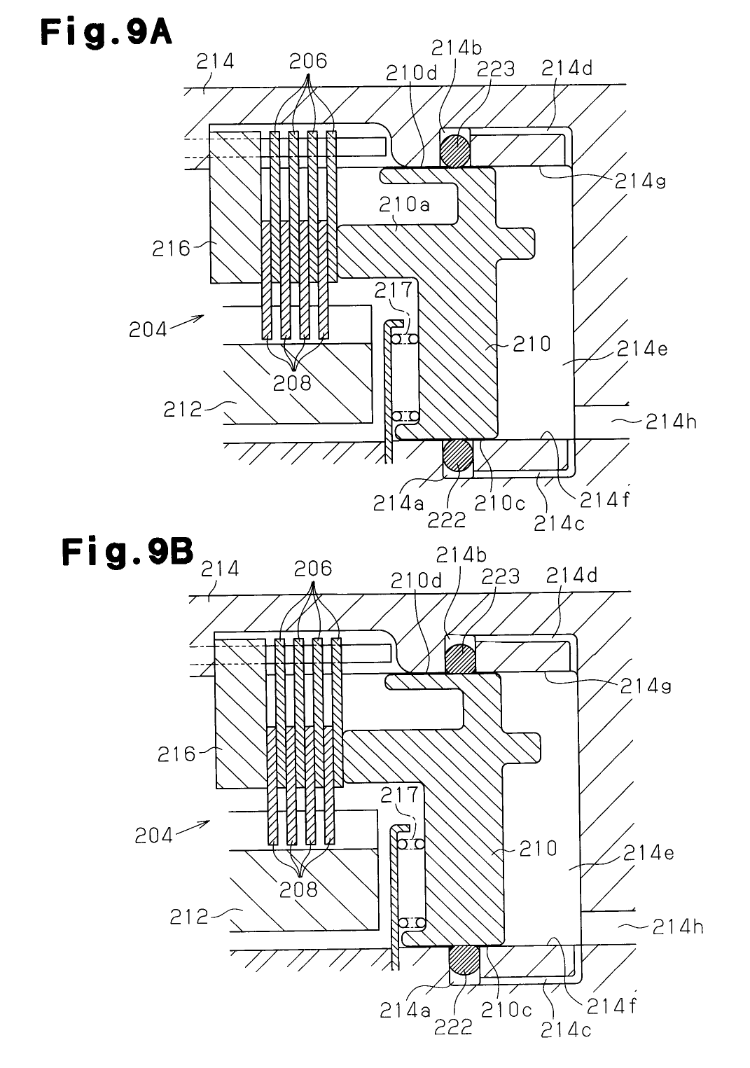

When the hydraulic pressure is supplied to the hydraulic pressure chamber 214e through the hydraulic passage 214h to engage the brake 204, the pressing projection 210a of the hydraulic piston 210 holds the driven plates 206 and the drive plates 208 as shown in FIG. 9A. This brakes the rotation of the rotor 212 as described above. When the hydraulic piston 210 stops moving, the hydraulic pressure in the hydraulic pressure chamber 214e is further raised. Accordingly, hydraulic pressure is further supplied to the seal ring grooves 214a, 214b through the hydraulic passages 214c, 214d, respectively. The seal rings 222, 223 are moved toward hydraulic piston 210. As shown in FIG. 9B, the seal rings 222, 223 are strongly pressed against the circumferential surface 210c, 210d of the hydraulic piston 210, respectively.

That is, as in the first embodiment, while the hydraulic piston 210 is being moved by the hydraulic pressure, each of the seal rings 222, 223 does not contacts or barely contacts the corresponding one of the circumferential surface 210c, 210d of the hydraulic piston 210. That is, since the hydraulic piston 210 does not receive a great sliding resistance, the hydraulic piston 210 can be rapidly moved so that the stroking amount is quickly increased. When the hydraulic piston 210 is stopped with the hydraulic fluid pressurized, the back pressure acting on the seal rings 222, 223 is further raised. This strongly presses the seal rings 222, 223 against the circumferential surface 210c, 210d of the hydraulic piston 210, respectively, so that the oil tightness between the hydraulic piston 210 and the hydraulic pressure chamber 214e is enhanced. The hydraulic fluid is thus prevented from leaking from the hydraulic pressure chamber 214e.

To disengage the brake 204, the hydraulic pressure in the hydraulic pressure chamber 214e is lowered. This lowers the back pressure acting on the seal rings 222, 223. Accordingly, each of the seal rings 222, 223 gradually lowers the pressure applied to the corresponding one of the circumferential surfaces 210c, 210d of the hydraulic piston 210. Therefore, the urging force of the compression spring 217 rapidly reduces the stroking amount of the hydraulic piston 210 so that the brake 204 is promptly disengaged.

The third embodiment described above has the following advantages.

(1) The seal rings 222, 223 are provided on the inner surfaces 214f, 214g of the hydraulic pressure chamber 214e, respectively. In this configuration, during a period in which the hydraulic fluid is pressurized and the hydraulic piston 210 is not moving, the sealing performance of the seal rings 222, 223 is further enhanced compared to that in a period in which the hydraulic piston 210 is moving.

Accordingly, the same advantages as those of the first embodiment are achieved.

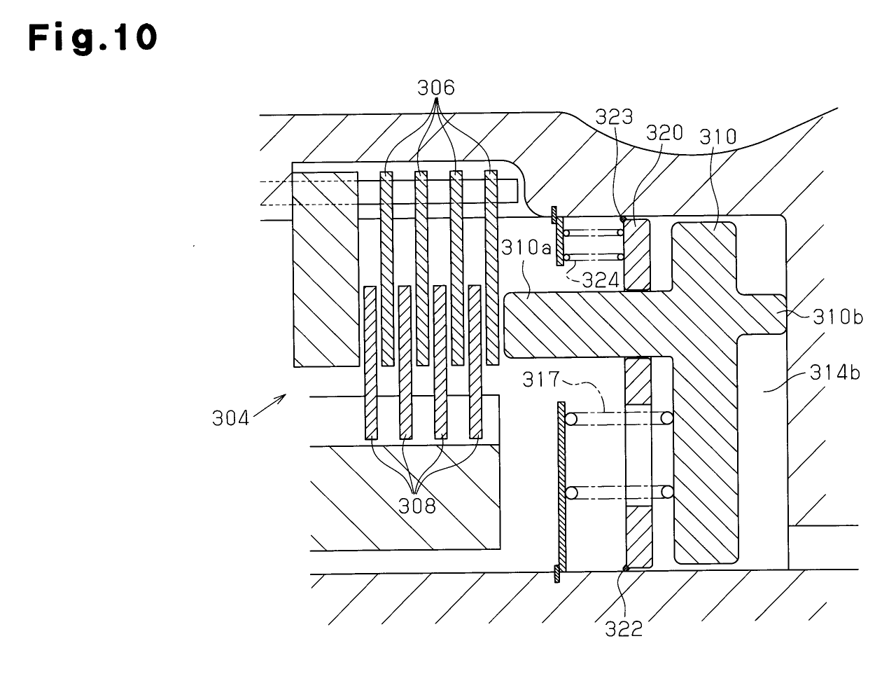

Like the brake 104 according to the second embodiment, a brake 304 according to a fourth embodiment includes a hydraulic piston 310, a compression spring 317 for the hydraulic piston 310, a seal support 320, and a spring 324 for the seal support 320 as shown in FIG. 10. The present embodiment is different from the second embodiment in that the moving range of the seal support 320 is substantially smaller than the moving range of the hydraulic piston 310.

As shown in FIG. 10, the spring 324 has the maximum length when receiving no external force. A range from this position to the position at which a pressing projection 310a of the hydraulic piston 310 engages the brake 304 corresponds to the substantial moving range of the hydraulic piston 310.

When the hydraulic pressure in the hydraulic pressure chamber 314b starts being raised, the hydraulic piston 310 moves independently at the initial stage of the movement. Thereafter, the hydraulic piston 310 contacts and is integrated with the seal support 320. In this state, the pressing projection 310a presses overlapping sections of driven plates 306 and drive plates 308, which form a multi-plate clutch, thereby engaging the brake 304.

When the hydraulic pressure in the hydraulic pressure chamber 314b is lowered, the hydraulic piston 310 is moved away from the multi-plate clutch by the urging force of the compression spring 317. As in the second embodiment, the movement of the seal support 320 is delayed by the sliding resistance of lip seal members 322, 323. This separates the hydraulic piston 310 from the seal support 320. Therefore, the stroking amount is rapidly reduced, and the brake 304 is promptly disengaged. Then, a stopper 310b of the hydraulic piston 310 contacts an end face of the hydraulic pressure chamber 314b, so that the hydraulic piston 310 returns to the initial position. The seal support 320 is stopped at a position where the urging force of the spring 324 disappears (the position of FIG. 10).

The fourth embodiment described above has the following advantages.

(1) The advantages of the second embodiment are achieved. Also, at an initial stage of the increase of the stroking amount, the hydraulic piston 310 is separated from the seal support 320. Thus, the responsiveness of the automatic transmission is improved not only in the case where the stroking amount is reduced to disengage the brake 304, but also in the case where the stroking amount is increased to engage the brake 304.

Other embodiments will now be described.

Although the illustrated embodiments provide hydraulic stroking devices applied to the brake of an automatic transmission, the present invention may be applied to the clutch of an automatic transmission. In a clutch also, the responsiveness of an automatic transmission is improved by reducing the sliding resistance without causing leakage of hydraulic fluid, regardless of the reduction in the number of the seal rings.

The hydraulic stroking devices of the illustrated embodiments may be applied to multi-plate clutches other than those of automatic transmissions. For example, the hydraulic stroking devices may be used for selectively engaging and disengaging a multi-plate clutch in a multi-plate clutch type limited slip differential used as a center differential. In such a case also, the responsiveness of the limited slip differential is improved by reducing the sliding resistance without causing leakage of hydraulic fluid, regardless of the reduction in the number of the seal rings.

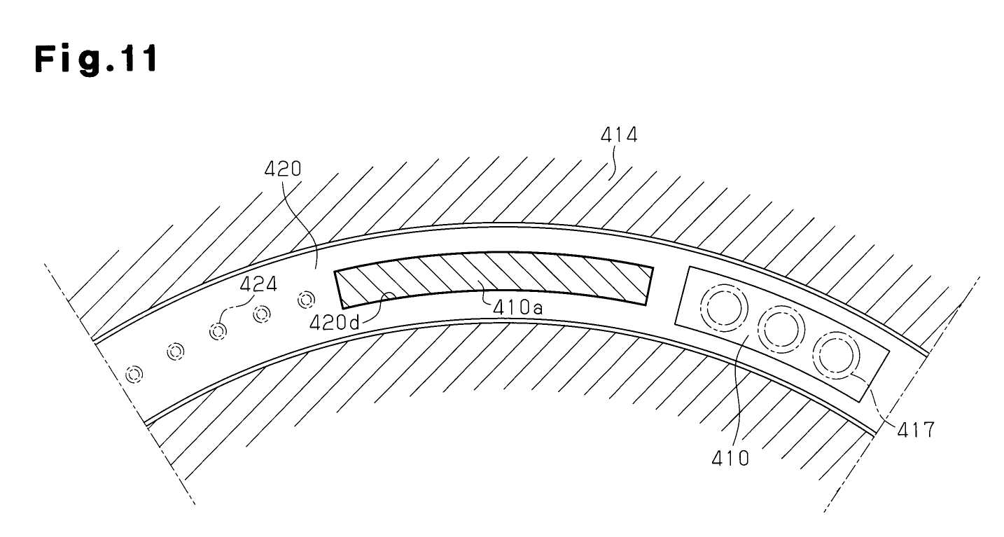

In the configuration of the second embodiment, the compression spring 124 for the seal support 120, the through hole 120d, through which the pressing projection 110a of the hydraulic piston 110 extends, and the compression spring 117 of the hydraulic piston 110 are located at different positions in the radial direction of the gearbox 114. The fourth embodiment hast the same configuration. Instead, as illustrated in the cross-sectional view of FIG. 11, compression springs 424 for a seal support 420, a through hole 420d through which a projection 410a of a hydraulic piston 410 extends, and compression springs 417 for the hydraulic piston 410 may be located in a common circumference of a gearbox 414. In this case, the radial size of the gearbox 414 is reduced, and the size of the automatic transmission is prevented from being undesirably increased.

In the second and fourth embodiments, the seal support has lip seal members. However, seal ring grooves may be formed on the circumferential surface of the seal support, and oil seal may be achieved by using normal seal rings.

The present examples and embodiments are to be considered as illustrative and not restrictive and the invention is not to be limited to the details given herein, but may be modified within the scope and equivalence of the appended claims.

What is claimed is:

1. A hydraulic stroking device that performs stroking action by adjusting a pressure of hydraulic fluid in a hydraulic fluid chamber, the device comprising:
a piston provided in the hydraulic fluid chamber, the piston receives the pressure of the hydraulic fluid and is moved by the pressure;
a sealing member that seals between a circumferential surface of the piston and an inner surface of the hydraulic fluid chamber; and
a variable sealing performance mechanism, wherein, when the piston is not moving with the hydraulic fluid being pressurized, the variable sealing performance mechanism enhances the sealing performance of the sealing member compared to the sealing performance in a state when the piston is being moved.

2. The device according to claim 1, wherein the sealing member is attached to one of the circumferential surface of the piston and the inner surface of the hydraulic fluid chamber, and wherein the variable sealing performance mechanism enhances the sealing performance by increasing the contact area of the sealing member with the other one of the circumferential surface of the piston and the inner surface of the fluid chamber.

3. The device according to claim 1, wherein the sealing member is attached to one of the circumferential surface of the piston and the inner surface of the hydraulic fluid chamber, and wherein the variable sealing performance mechanism enhances the sealing performance by raising the pressure of the sealing member applied to the other one of the circumferential surface of the piston and the inner surface of the hydraulic fluid chamber.

4. The device according to claim 1, wherein the sealing member is attached to one of the circumferential surface of the piston and the inner surface of the hydraulic fluid chamber, and wherein the variable sealing performance mechanism enhances the sealing performance by moving the sealing member toward the other one of the circumferential surface of the piston and the inner surface of the hydraulic fluid chamber.

5. The device according to claim 2, wherein the variable sealing performance mechanism applies, as a back pressure, the pressure of the hydraulic fluid to the sealing member, and adjusts the back pressure thereby varying the sealing performance.

6. The device according to claim 5, wherein the variable sealing performance mechanism has a hydraulic passage that extends in the piston or in a member defining the hydraulic fluid chamber to conduct hydraulic fluid from the hydraulic fluid chamber to a back surface of the sealing member.

7. The device according to claim 6, wherein the sealing member is a seal ring provided in a seal ring groove formed in one of the circumferential surface of the piston and the inner surface of the hydraulic fluid chamber, and wherein the hydraulic passage has an opening in an inner bottom of the seal ring groove.

8. The device according to claim 1, further comprising an urging member that applies an urging force to the piston, the urging force acting in a direction opposite to the direction in which the pressure of the hydraulic fluid in the fluid chamber urges the piston.

9. A planetary gear automatic transmission comprising the hydraulic stroking device according to claim 1 and either a clutch or a brake, wherein the stroking device functions to selectively engage and disengage the clutch or brake.

10. A clutch apparatus comprising the hydraulic stroking device according to claim 1 and a multi-plate clutch, wherein the stroking device functions to selectively engage and disengage the multi-plate clutch.

11. A hydraulic stroking device that performs stroking action by adjusting a pressure of hydraulic fluid in a hydraulic fluid chamber, the device comprising:
a piston provided in the hydraulic fluid chamber, the piston receives the pressure of the hydraulic fluid and is moved by the pressure, the piston having a first surface that receives the pressure of the hydraulic fluid in the hydraulic fluid chamber, and a second surface located on a side opposite to the first surface;
a seal support that is separately formed from the piston and located in the hydraulic fluid chamber, wherein the seal support selectively intimately contacts and separates from the second surface of the piston;
an urging member urging the seal support toward the second surface of the piston; and
a sealing member that is provided in the seal support and seals between an inner surface of the hydraulic fluid chamber and the seal support.

12. The device according to claim 11, further comprising an urging member that applies an urging force to the piston, the urging force acting in a direction opposite to the direction in which the pressure of the hydraulic fluid in the fluid chamber urges the piston.

13. The device according to claim 11, wherein the moving range of the piston is equal to the moving range of the seal support.

14. The device according to claim 11, wherein the moving range of the seal support is smaller than the moving range of the piston.

15. A planetary gear automatic transmission comprising the hydraulic stroking device according to claim 11 and either a clutch or a brake, wherein the stroking device functions to selectively engage and disengage the clutch or brake.

16. A clutch apparatus comprising the hydraulic stroking device according to claim 11 and a multi-plate clutch, wherein the stroking device functions to selectively engage and disengage the multi-plate clutch.
